(19) United States
(12) Patent Application Publication
(10) Pub. No.: US 2007/0103704 A1
(43) Pub. Date: May 10, 2007

(54) METHODS AND APPARATUSES FOR MERGING AND OUTPUTTING IMAGES

(75) Inventors: Mei Tai Chou, Taipei City (TW); Chun Jen Lee, Taipei County (TW)

Correspondence Address: QUINTERO LAW OFFICE, PC, 2210 MAIN STREET, SUITE 200, SANTA MONICA, CA, 90405, US

(73) Assignee: BENQ CORPPORATION, TAOYUAN (TW)

(21) Appl. No.: 11/557,866

(22) Filed: Nov. 8, 2006

(30) Foreign Application Priority Data
Nov. 10, 2005 (TW) TW94139451

(51) Int. Cl. G06F 15/00; G06K 15/00

(52) U.S. Cl. 358/1.9; 358/448; 358/3.27

(57) ABSTRACT

An image processing apparatus comprises an image input device, an image output device and a processing unit. The processing unit coupled to the image input device and the image output device acquires a plurality of first bitmap image via the image input device, generates a second bitmap image by merging the first bitmap images, generates a third bitmap image by reducing the second bitmap image and prints the third bitmap image via the image output device, wherein each first bitmap image corresponds to a portion of a printed page.

### BACKGROUND

The present invention relates to image processing, and more particularly, to methods and apparatuses for merging and outputting images.

Conventional image processing apparatuses such as facsimile machines, multi-function printers or others, acquire images on printed pages via optical character reader (OCR) modules therein and print the acquired images. The image processing apparatuses may provide additional functions to print, such as enlarging images, enlarging images, fitting to page, clone, poster or others. The clone function reduces an image, replicates the reduced image to multiple copies and arranges the replicated ones for printing. The poster function enlarges an image and divides the enlarged image into multiple pages for printing. However, the conventional image processing apparatuses provide no function to acquire an image printed on a paper larger than a scanning zone of an OCR module for subsequent printing.

### SUMMARY

Apparatuses for image processing are provided. An embodiment of an apparatus for image processing comprises an image input device, an image output device and a processing unit. The processing unit coupled to the image input device and the image output device acquires multiple first bitmap images via the image input device, generates a second bitmap image by merging the first bitmap images, generates a third bitmap image by reducing the second bitmap image and prints the third bitmap image via the image output device, wherein each first bitmap image corresponds to a portion of a printed page.

An embodiment of a storage device may further comprise a storage device. The processing unit stores the second bitmap image or the third bitmap image in the storage device.

An embodiment of a processing unit may further generate multiple fourth bitmap images by reducing complexity of the first bitmap images, determine a relative moved coordinate set corresponding to each of the two neighboring first bitmap images by analyzing overlapping regions of each of the two neighboring fourth bitmap images and generate the second bitmap image by merging the first bitmap images according to the determined relative moved coordinate sets. Each fourth bitmap image may comprise halftone or luminance data of pixels of the corresponding first bitmap image. An embodiment of a processing unit may further acquire a merge mode, determine at least one adjacent edge of each fourth bitmap image and determine a neighboring fourth bitmap image adjacent to the determined adjacent edge according to the acquired merge mode. The overlapping regions corresponding to the determined relative moved coordinate set for each of the two neighboring fourth bitmap images have the minimum difference therebetween.

An embodiment of a processing unit may further determine a relative moved coordinate set corresponding to each of the two neighboring first bitmap images by analyzing overlapping regions of each of the two neighboring first bitmap images and generate the second bitmap image by merging the first bitmap images according to the determined relative moved coordinate sets. An embodiment of a processing unit may further acquire a merge mode, determine at least one adjacent edge of each first bitmap image and determine a neighboring first bitmap image adjacent to the determined adjacent edge according to the acquired merge mode. The overlapping regions corresponding to the determined relative moved coordinate set for each of the two neighboring first bitmap images have the minimum difference therebetween.

Methods for image processing are provided. An embodiment of a method comprises the following steps. Multiple first bitmap images are acquired, and each first bitmap image corresponds to a portion of a printed page. A second bitmap image is generated by merging the first bitmap images. A third bitmap image is generated by reducing the second bitmap image. The third bitmap image is then printed.

An embodiment of a method for image processing may further comprise storing the second bitmap image or the third bitmap image.

An embodiment of a method for image processing may further comprise the following steps. Multiple fourth bitmap images are generated by reducing complexity of the first bitmap images, wherein each fourth bitmap image comprises halftone or luminance data of pixels of the corresponding first bitmap image. A relative moved coordinate set corresponding to each of the two neighboring first bitmap images is determined by analyzing overlapping regions of each of the two neighboring fourth bitmap images. The second bitmap image is generated by merging the first bitmap images according to the determined relative moved coordinate sets. A merge mode is acquired. At least one adjacent edge of each fourth bitmap image is determined according to the acquired merge mode. A neighboring fourth bitmap image adjacent to the determined adjacent edge is determined. The overlapping regions corresponding to the determined relative moved coordinate set for each of the two neighboring fourth bitmap images have the minimum difference therebetween.

An embodiment of a method for image processing may further comprise the following steps. A relative moved coordinate set corresponding to each of the two neighboring first bitmap images is determined by analyzing overlapping regions of each of the two neighboring first bitmap images. The second bitmap image is generated by merging the first bitmap images according to the determined relative moved coordinate sets. A merge mode is acquired. According to the acquired merge mode, at least one adjacent edge of each first bitmap image is determined. A neighboring first bitmap image adjacent to the determined adjacent edge is determined. The overlapping regions corresponding to the determined relative moved coordinate set for each of the two neighboring first bitmap images have the minimum difference therebetween.

A machine-readable storage medium storing a computer program which, when executed by an image processing apparatus, performs the method of image processing is also provided.

### BRIEF DESCRIPTION OF DRAWINGS

The invention will become more fully understood by referring to the following detailed description with reference to the accompanying drawings, wherein:

FIG. 1 is a diagram of a hardware environment applicable to an embodiment of an image processing apparatus;

FIGS. 2 and 3 are flowcharts of embodiments of methods for merging and outputting images;

FIG. 4a illustrates an exemplary merge mode for long edges;

FIG. 4b illustrates an exemplary merge mode for short edges;

FIGS. 4c and 4d illustrate exemplary merge modes for dual edges;

FIG. 5 is a diagram of a storage medium storing a computer program for merging and outputting images.

### DETAILED DESCRIPTION

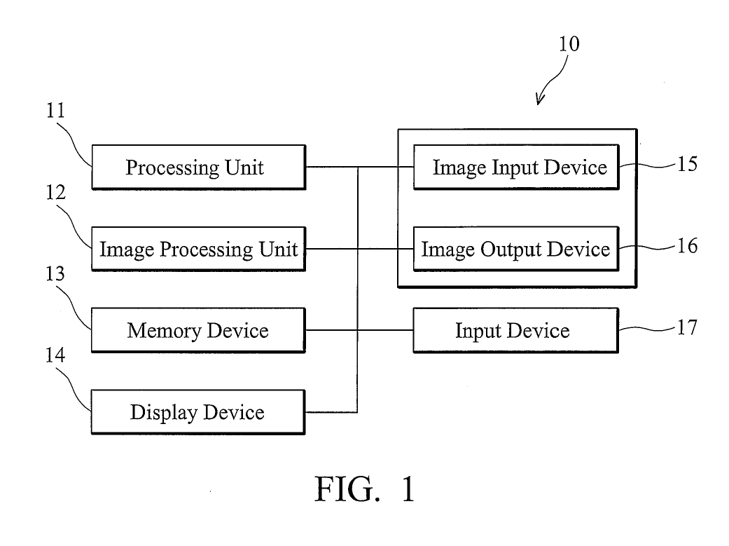

FIG. 1 is a diagram of a hardware environment applicable to an embodiment of an image processing apparatus 10 comprising a processing unit 11, an image processing unit 12, a memory device 13, a display device 14, an image input device 15, an image output device 16 and an input device 17. The processing unit 11 couples to the image processing unit 12, memory device 13, display device 14, image input device 15, image output device 16 and input device 17 to control their operations. The image input device 15 reads a printed page or transparency and converts it into a bitmap image, which is a pattern of dots. The processing unit 11 acquires multiple bitmap images via the image input device 15, each bitmap image corresponding to a portion of a printed page. The processing unit 11 merges the acquired bitmap images into a single bitmap image, reduces the merged bitmap images and prints the reduced bitmap image via the image output device 16. The memory device 13 such as a dynamic random access memory (DRAM), synchronous DRAM (SDRAM) or similar volatile memory device, stores bitmap images acquired by the image input device 15 or a bitmap image merged by the processing unit 11. The image output device 16 prints the merged bitmap image on a suitable print medium such as paper.

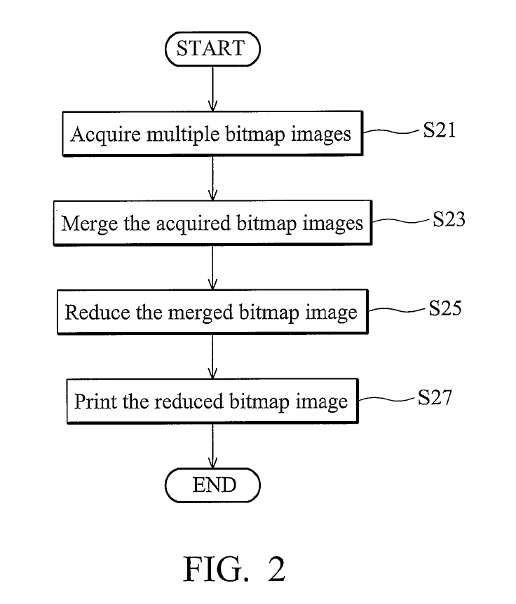

FIG. 2 is a flowchart of an embodiment of a method for merging and outputting images, performed by the processing unit 11. In step S21, multiple bitmap images are acquired, wherein each acquired bitmap image corresponds to a portion of a printed page. In step S23, the acquired bitmap images are merged into a single bitmap image. In step S25, the merged bitmap image is reduced. In step S27, the reduced bitmap image is printed.

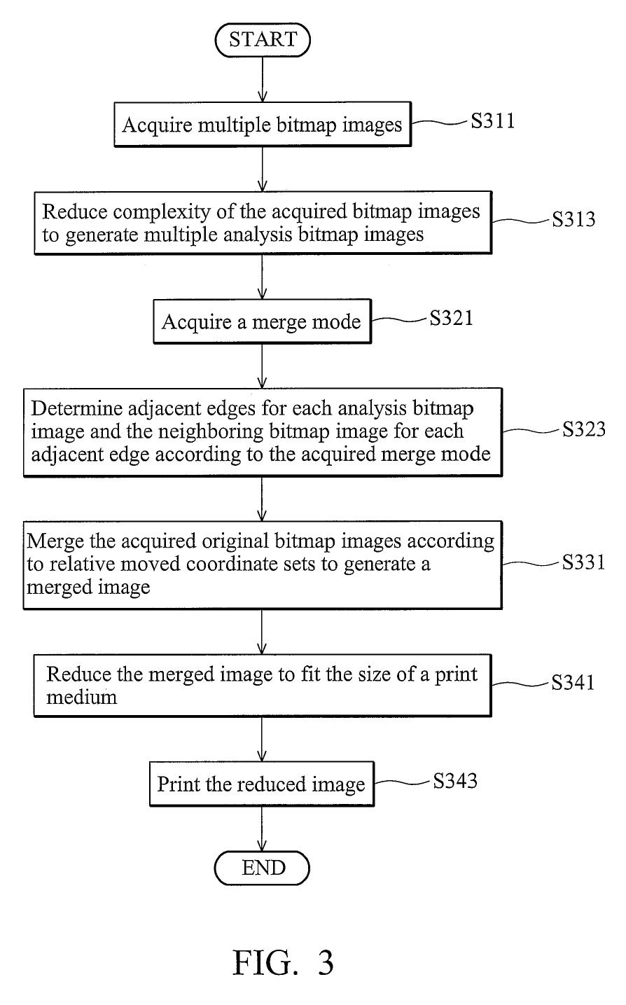

FIG. 3 is a flowchart of an embodiment of a method for merging and outputting images, performed by the processing unit 11. In step S311, multiple bitmap images are acquired. The bitmap images are read and converted from a printed page by the image input device 15, each bitmap image corresponding to a portion of the printed page. In step S313, in order to save computation power, complexity of the acquired bitmap images is reduced to generate multiple analysis bitmap images. The method may acquire halftone or luminance data of pixels of the acquired bitmap image by various image processing methods to generate analysis bitmap images (i.e. bitmap images containing halftone or luminance data of pixels).

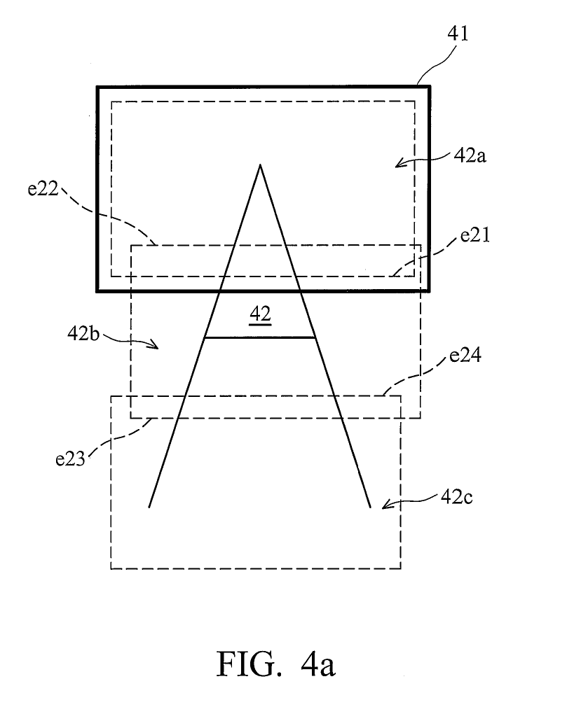

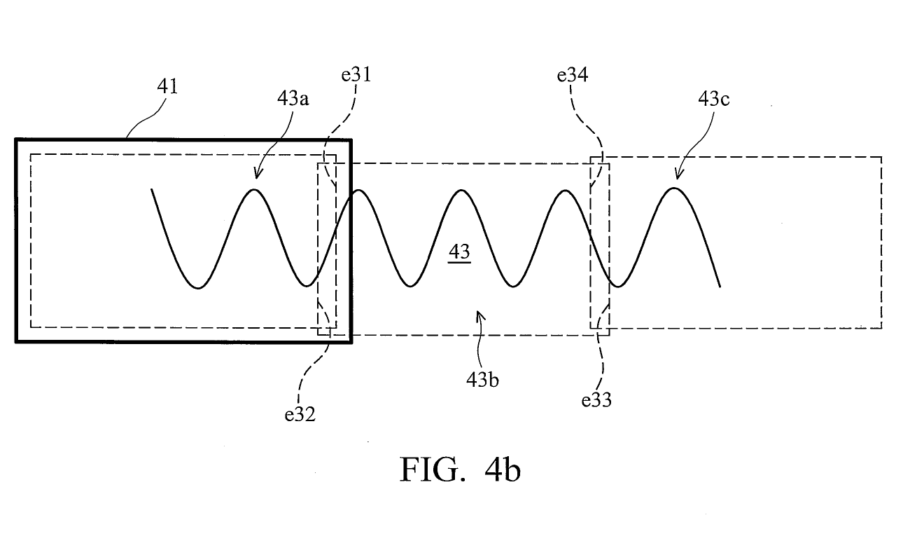

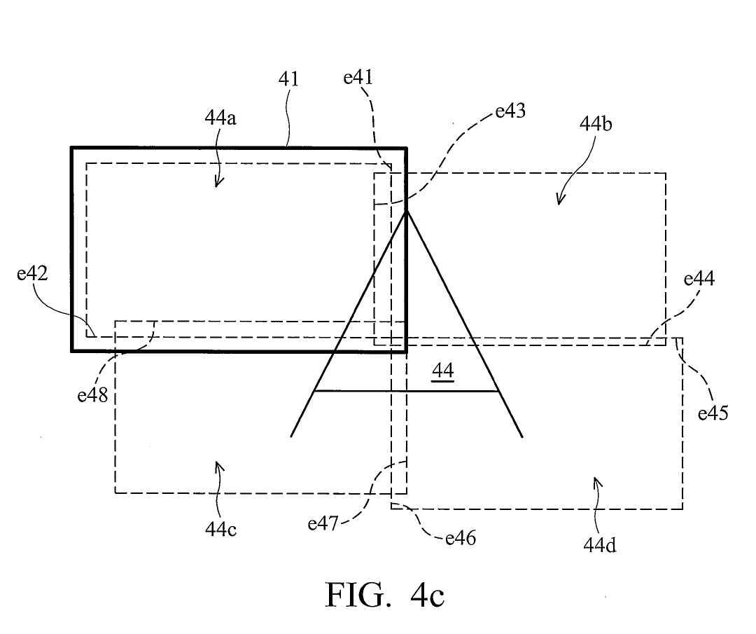

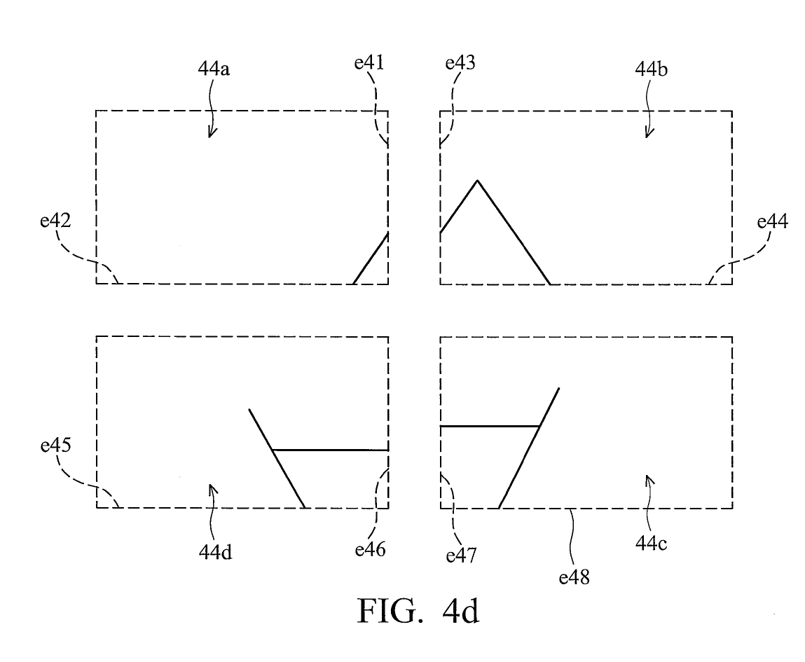

In step S321, a merge mode is acquired. The merge mode is set by a user via the input device 17 such as a keyboard, a touch panel or similar. FIGS. 4a, 4b, 4c and 4d are diagrams illustrating exemplary merge modes. FIG. 4a illustrates an exemplary merge mode for long edges. A printed page 42 is larger than an image acquisition region 41 scanned by an OCR module of the image input device 15. The image input device 15 acquires three analysis bitmap images such as 42a, 42b and 42c, wherein edges e21 and e22 are adjacent edges of bitmap images 42a and 42b, and edges e23 and e24 are adjacent edges of bitmap images 42b and 42c. FIG. 4b illustrates an exemplary merge mode for short edges. A printed page 43 is larger than the image acquisition region 41 scanned by an OCR module of the image input device 15. The image input device 15 acquires three analysis bitmap images such as 43a, 43b and 43c, wherein edges e31 and e32 are adjacent edges of bitmap images 43a and 43b, and edges e33 and e34 are adjacent edges of bitmap images 43b and 43c. FIG. 4c illustrates an exemplary merge mode for dual edges. A printed page 44 is larger than the image acquisition region 41 scanned by an OCR module of the image input device 15. The image input device 15 acquires four analysis bitmap images such as 44a, 44b, 44c and 44d, wherein edges e41 and e43 are adjacent edges of bitmap images 44a and 44b, edges e44 and e45 are adjacent edges of bitmap images 44b and 44d, edges e46 and e47 are adjacent edges of bitmap images 44c and 44d, and edges e42 and e48 are adjacent edges of bitmap images 44a and 44c. FIG. 4d illustrates an exemplary merge mode of dual edges, similar to FIG. 4c. A printed page 44 is larger than the image acquisition region 41 scanned by an OCR module of the image input device 15. The image input device 15 acquires four analysis bitmap images such as 44a, 44b, 44c and 44d.

In step S323, adjacent edges for each analysis bitmap image and the neighboring bitmap image for each adjacent edge are determined according to the acquired merge mode. Referring to FIG. 4a, adjacent edge e21 and its neighboring bitmap image 42b are determined for the analysis bitmap image 42a. For the analysis bitmap image 42b, adjacent edges e22 and e23 and their neighboring bitmap images 42a and 42c are respectively determined. Adjacent edge e24 and its neighboring bitmap image 42b are determined for the analysis bitmap image 42c. In step S331, a relative moved coordinate set corresponding to each of two adjacent original bitmap images (i.e. bitmap images acquired by step S311) is determined by analyzing overlapping regions of each of two adjacent analysis bitmap images, and original bitmap images are merged according to the determined relative moved coordinate sets to generate a merged image. For each of two adjacent analysis bitmap image, step S331 may repeatedly move one of two adjacent analysis bitmap images based on a relative moved coordinate set, enabling a portion of the adjacent region of the moved analysis bitmap image to overlap a portion of adjacent region of the other analysis bitmap image. After each movement, the difference between pixels of the overlapping regions of two adjacent analysis bitmap images is calculated. One relative moved coordinate set corresponding to the minimum difference is determined among multiple relative moved coordinate sets. The relative moved coordinate set including a relative moved X coordinate and a relative moved Y coordinate.

In step S341, the merged image is reduced to fit the size of the print medium. In step S343, the reduced image is printed. Those skilled in the art may realize that the steps S341 and S343 are omitted and the merged bitmap image is directly stored in the memory device 13.

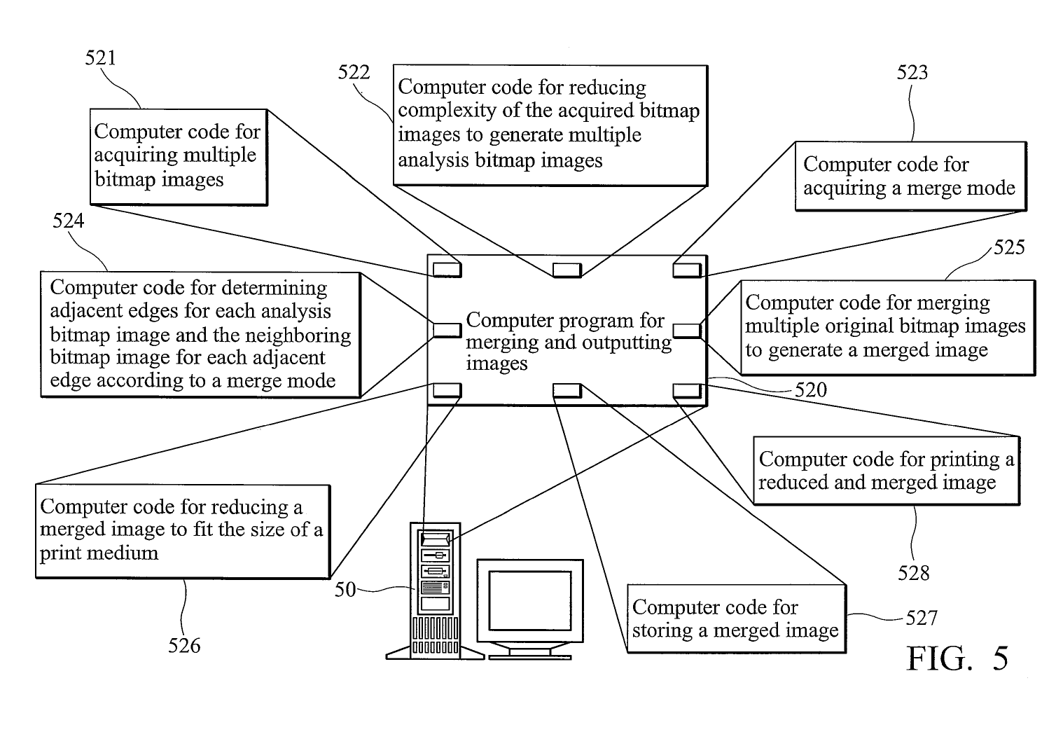

Also disclosed is a storage medium as shown in FIG. 5 storing a computer program 520 providing the disclosed methods for merging and outputting images. The computer program includes a storage medium 50 having computer readable program code therein for use in a computer system. The computer readable program code comprises at least computer readable program code 521 acquiring multiple bitmap images, computer readable program code 522 reducing complexity of the acquired bitmap images to generate multiple analysis bitmap images, computer readable program code 523 acquiring a merge mode, computer readable program code 524 determining adjacent edges for each analysis bitmap image and the neighboring bitmap image for each adjacent edge according to a merge mode, computer readable program code 525 merging multiple original bitmap images to generate a merged image, computer readable program code 526 reducing a merged image to fit the size of a print medium, computer readable program code 527 storing a merged image and computer readable program code 528 printing a reduced and merged image.

Image processing apparatuses and methods for merging and outputting images, or certain aspects or portions thereof, may take the form of program code (i.e., instructions) embodied in tangible media, such as floppy diskettes, CD-ROMS, hard drives, nonvolatile memory devices, or any other machine-readable storage medium, wherein, when the program code is loaded into and executed by a machine, such as an image processing apparatus or similar, the machine becomes an apparatus for practicing the invention. The disclosed methods and apparatuses may also be embodied in the form of program code transmitted over some transmission medium, such as electrical wiring or cabling, through fiber optics, or via any other form of transmission, wherein, when the program code is received and loaded into and executed by an image processing apparatus, such as a facsimile machine, a multi-function printer or similar, the machine becomes an apparatus for practicing the invention.

Certain terms are used throughout the description and claims to refer to particular system components. As one skilled in the art will appreciate, consumer electronic equipment manufacturers may refer to a component by different names. This document does not intend to distinguish between components that differ in name but not function.

While the invention has been described in terms of preferred embodiment, it is not intended to limit the invention to the precise embodiments disclosed herein. Those who are skilled in this technology can still make various alterations and modifications without departing from the scope and spirit of this invention. Therefore, the scope of the invention shall be defined and protected by the following claims and their equivalents.

What is claimed is:

1. An apparatus for image processing comprising:
an image input device;
an image output device; and
a processing unit coupling to the image input device and the image output device, acquiring a plurality of first bitmap images via the image input device, generating a second bitmap image by merging the first bitmap images, generating a third bitmap image by reducing the second bitmap image, and printing the third bitmap image via the image output device,
wherein each first bitmap image corresponds to a portion of a printed page.

2. The apparatus as claimed in claim 1 further comprising a storage device, wherein the processing unit stores the second bitmap image or the third bitmap image in the storage device.

3. The apparatus as claimed in claim 1 wherein the processing unit generates a plurality of fourth bitmap images by reducing complexity of the first bitmap images, determines a relative moved coordinate set corresponding to each of the two neighboring first bitmap images by analyzing overlapping regions of each of the two neighboring fourth bitmap images and generates the second bitmap image by merging the first bitmap images according to the determined relative moved coordinate sets.

4. The apparatus as claimed in claim 3 wherein each fourth bitmap image comprises halftone or luminance data of pixels of the corresponding first bitmap image.

5. The apparatus as claimed in claim 3 wherein the processing unit acquires a merge mode, determines at least one adjacent edge of each fourth bitmap image and determines a neighboring fourth bitmap image adjacent to the determined adjacent edge according to the acquired merge mode.

6. The apparatus as claimed in claim 3 wherein the overlapping regions corresponding to the determined relative moved coordinate set for each of the two neighboring fourth bitmap images have the minimum difference therebetween.

7. The apparatus as claimed in claim 1 wherein the processing unit determines a relative moved coordinate set corresponding to each of the two neighboring first bitmap images by analyzing overlapping regions of each of the two neighboring first bitmap images and generates the second bitmap image by merging the first bitmap images according to the determined relative moved coordinate sets.

8. The apparatus as claimed in claim 7 wherein the processing unit acquires a merge mode, determines at least one adjacent edge of each first bitmap image and determines a neighboring first bitmap image adjacent to the determined adjacent edge according to the acquired merge mode.

9. The apparatus as claimed in claim 7 wherein the overlapping regions corresponding to the determined relative moved coordinate set for each of the two neighboring first bitmap images have the minimum difference therebetween.

10. A method for image processing, comprising:
acquiring a plurality of first bitmap images, each first bitmap image corresponding to a portion of a printed page;
generating a second bitmap image by merging the first bitmap images;
generating a third bitmap image by reducing the second bitmap image; and
printing the third bitmap image.

11. The method as claimed in claim 10 further comprising storing the second bitmap image or the third bitmap image.

12. The method as claimed in claim 10 further comprising:
generating a plurality of fourth bitmap images by reducing complexity of the first bitmap images;
determining a relative moved coordinate set corresponding to each of the two neighboring first bitmap images by analyzing overlapping regions of each of the two neighboring fourth bitmap images; and
generating the second bitmap image by merging the first bitmap images according to the determined relative moved coordinate sets.

13. The method as claimed in claim 12 wherein each fourth bitmap image comprises halftone or luminance data of pixels of the corresponding first bitmap image.

14. The method as claimed in claim 12 further comprising:
acquiring a merge mode;
according to the acquired merge mode, determining at least one adjacent edge of each fourth bitmap image; and
determining a neighboring fourth bitmap image adjacent to the determined adjacent edge.

15. The method as claimed in claim 12 wherein the overlapping regions corresponding to the determined relative moved coordinate set for each of the two neighboring fourth bitmap images have the minimum difference therebetween.

16. The method as claimed in claim 10 further comprising:
determining a relative moved coordinate set corresponding to each of the two neighboring first bitmap images by analyzing overlapping regions of each of the two neighboring first bitmap images; and
generating the second bitmap image by merging the first bitmap images according to the determined relative moved coordinate sets.

17. The method as claimed in claim 16 further comprising:
acquiring a merge mode;
determining at least one adjacent edge of each first bitmap image; and
determining a neighboring first bitmap image adjacent to the determined adjacent edge according to the acquired merge mode.

18. The method as claimed in claim 16 wherein the overlapping regions corresponding to the determined relative moved coordinate set for each of the two neighboring first bitmap images have the minimum difference therebetween.

19. A machine-readable storage medium for storing a computer program which, when executed by an image processing apparatus, performs a method for image processing, the method comprising:
acquiring a plurality of first bitmap images, each first bitmap image corresponding to a portion of a printed page;
generating a second bitmap image by merging the first bitmap images;
generating a third bitmap image by reducing the second bitmap image; and
printing the third bitmap image.
